(19) United States
(12) Patent Application Publication
(10) Pub. No.: US 2023/0332430 A1
(43) Pub. Date: Oct. 19, 2023

(54) MODULAR FENCE SYSTEM

(71) Applicant: ORIGIN POINT BRANDS LLC, Summerville, SC (US)

(72) Inventors: Duane E Langenwalter, Monroe, CT (US); Basil C Peyton, Deluth, GA (US)

(21) Appl. No.: 18/341,470

(22) Filed: Jun. 26, 2023

Related U.S. Application Data
(63) Continuation of application No. 16/312,134, filed on Dec. 20, 2018, now Pat. No. 11,725,414.
(60) Provisional application No. 62/346,241, filed on Jun. 6, 2016.

(51) Int. Cl. E04H 17/18; E04H 17/16; E06B 11/02

(52) U.S. Cl. CPC E04H 17/185; E04H 17/18; E04H 17/161; E06B 11/021

(57) ABSTRACT

A modular fence system includes a plurality of fence panels, each having top, bottom, left side, and right side edges. The left side edge may define a first profile, and he right side edge may define a second profile, the second profile being complementary to the first profile, whereby the left side edge of one panel may be disposed in side-by-side relationship to the right side edge of a second panel. The top, bottom, left side, and right side edges may define a periphery, with a plurality of barrier members residing within the periphery. Each panel may also include a strengthening feature integral with a plurality of the barrier members. A first hinge may carried on the left side edge, and a second hinge carried on the right side edge and configured to align with the first hinge.

### TECHNOLOGICAL FIELD

This disclosure relates to a modular fence system. More particularly, it relates to a fence system with modular panels, each panel carrying outboard helical connectors, the system also including a latch by which a panel may be thereby used as a gate.

### CROSS-REFERENCE TO RELATED APPLICATIONS

This application is a continuation of, and claims the benefit of priority to, U.S. application Ser. No. 16/312,134, filed Dec. 20, 2018, which claims the benefit of priority to international application PCT/US2017/036102, filed Jun. 6, 2017, which claims the benefit of priority to provisional U.S. Patent Application Ser. No. 62/346,241 filed on Jun. 6, 2016, the entire scope and content of which are hereby incorporated herein by reference.

### BACKGROUND OF THE INVENTION

A fence is a barrier. It marks a boundary, controls access, provides an enclosure, protects, and/or decorates. An upright structure, historically a fence has been made of wood or metal.

And historically a fence has not been easy to construct. Usually posts must first be embedded in the ground, often in concrete, their locations premeasured. Railings, mesh, pickets, and like barrier elements are then attached to the posts, requiring additional labor. Once installed, the fence, so constructed, is difficult to relocate.

Premanufactured fencing components lessen some of that labor. For example, if the posts are first properly located and installed, and carefully distanced from each other so as to receive the premanufactured barrier elements, premanufactured barrier elements might be affixed in between the posts, thereby reducing some of the labor. However, such an improvement has not fully provided for ease and flexible installation by the end use.

It is more desirable for fencing to be available as fully pre-assembled as possible, yet adaptable for user preferences, as pre-assembly would simplify installation and would reduce costs as a result of economies of scale.

Modularity of pre-assembled fencing panels is also desirable. Inasmuch as plans may be altered during installation of fencing, or additional fencing may be discovered to be desirable after installation of an initial run, or later replacement may be desired of a section of fencing damaged after installation, modularity of design would allow easy and aesthetically matching and consistent final results.

It would also be desirable to provide a fence design with components that may be manufactured at a first location better suited for efficient manufacturing, and shipped to a second location for sale to an end user, who might then easily assemble the components into a finished barrier. In such a context, it would be desirable for a fencing design to comprise a minimal number of components. Ideally, those same components should at the same time be of a design allowing efficient connectivity, preferably requiring use only of simple and inexpensive tools, and, once assembled, complement the structural function of each other.

Finally, for fencing designed to be manufactured at a first location and shipped to a second location for final assembly into finished barrier, it would be desirable for the design of the fencing components and the finished assembly to be such that the finished assembly is sturdy, structurally sound, tight, and without loose parts.

The fencing products previously known do not ideally address the foregoing objectives.

### BRIEF SUMMARY OF THE INVENTION

In response to the difficulties and problems encountered before, a new modular fence system has been discovered that is simple, easy to use, includes a minimal number of components, and provides for great versatility to the user.

In accordance with certain aspects of certain embodiments of the present technology, a modular fence system includes a plurality of fence panels, each fence panel having a top edge and an opposed bottom edge, a left side edge and an

opposed right side edge. The left side edge may define along its length a first profile, and the right side edge may define along its length a second profile, the second profile being complementary to the first profile, whereby the left side edge of a first panel may be disposed in side-by-side relationship along its length to the right side edge of a second panel along its length. The top edge, bottom edge, left side edge, and right side edge may define a periphery, with a plurality of barrier members residing within the periphery. Each panel may also include a strengthening feature, the strengthening feature integral with a plurality of the barrier members. Further, each panel may include a first hinge, the first hinge carried on the left side edge, and a second hinge, the second hinge carried on the right side edge and configured to align with the first hinge of a second panel.

In accordance with additional aspects of other embodiments of the present technology, the top edge and the bottom edge of each panel may reside in a single plane, and the strengthening feature may reside outside the single plane.

In accordance with yet additional aspects of other embodiments of the present technology, a first group of the barrier members may cross a plurality of the remaining members of the barrier members.

In accordance with still further aspects of other embodiments of the present technology, each barrier member may have a first end and an opposed second end, and the first and second ends of the barrier members may reside within the periphery.

In accordance with yet still further aspects of other embodiments of the present technology, a first group of the barrier members may be generally horizontal and a plurality of the remaining members of the barrier members may be generally vertical. In particular embodiments, the generally horizontal barrier members may be attached to a plurality of the generally vertical barrier members. In certain configurations, the generally horizontal barrier members are attached to all of the generally vertical barrier members.

Some examples of the modular fence system may include first and second hinges that are helical and disposed outboard of the panel. In individual forms of some embodiments, the hinges may each attached to a vertical barrier member.

Selective illustrations of the modular fence system may include the top edge, bottom edge, left side edge, and right side edge of each panel each defining a side length, each edge being devoid of additional elements having the side length.

In accordance with other aspects of other embodiments of the present technology, a modular fence system may include a plurality of fence panels, each fence panel having a first plurality of barrier members residing horizontally in a parallel relationship to one another, and a second plurality of barrier members residing vertically in a parallel relationship to one another. Each horizontal barrier member may be attached to a plurality of the vertical barrier members. The uppermost horizontal barrier member may define a top edge to the panel and the lowermost horizontal barrier member may define a bottom edge to the panel. The left-most vertical barrier member may define a left edge to the panel and further define a first profile along its length. The right-most vertical barrier member may define a right edge to the panel and further define a second profile along its length, the second profile being complementary to the first profile, whereby the left edge of a first panel may be disposed in side-by-side relationship along its length to the right edge of a second panel along its length. A first strengthening feature may be included, the first strengthening feature integral with a plurality of the vertical barrier members. Each panel may also include a first hinge, the first hinge carried on and outboard of the left edge, and a second hinge, the second hinge carried on and outboard of the right side edge and configured to align with a the first hinge of a second said panel.

In accordance with additional aspects of other embodiments of the present technology, the top edge and the bottom edge of each panel may be parallel and define between them a plane, and the first strengthening feature may reside outside the plane.

In accordance with yet additional aspects of other embodiments of the present technology, each horizontal barrier member may be attached to each of vertical barrier members.

In accordance with still further aspects of other embodiments of the present technology, each panel further may include a second strengthening feature, the second strengthening feature residing outside the plane, the first strengthening feature located proximate to the top edge, the second strengthening feature located proximate to the bottom edge.

In accordance with yet still further aspects of other embodiments of the present technology, the first and second hinge of each panel may be helical, may be identical, may each attached to a vertical barrier member, and may each be outboard of the panel.

In particular configurations, the top edge, bottom edge, left edge, and right edge of each panel may each define a side length, each of the edges being devoid of additional elements having said side length.

In certain examples, the uppermost horizontal barrier member, the lowermost horizontal barrier member, the left-most vertical barrier member, and the right-most barrier member of each panel may define a panel periphery, and the entireties of the other horizontal and vertical barrier members may reside within the panel periphery.

In accordance with other certain aspects of some embodiments of the present technology, a modular fence system may include a plurality of fence panels, each fence panel being identical. Each fence panel may have a first plurality of barrier members, the first plurality of barrier members being identical, being rectilinear, and residing horizontally in parallel spaced-apart relationship to one another. A second plurality of barrier members may reside vertically in parallel spaced-apart relationship to one another. Each horizontal barrier member may be attached to a plurality of vertical barrier members. The uppermost horizontal barrier member, the lowermost horizontal barrier member, the left-most vertical barrier member, and the right-most vertical barrier member may together define the periphery of the fence panel, and the uppermost horizontal barrier member and the lowermost horizontal barrier member may be parallel and define between them a plane. The left-most vertical barrier member may define a first profile along its length and the right-most vertical barrier member may define a second profile along its length, the second profile being complementary to the first profile, whereby the left edge of a first panel may be disposed in side-by-side relationship along its length to the right edge of a second panel along its length. A first vertical barrier member and a second vertical barrier member of the second plurality may be identical, may each be formed to include along its length a third profile, the third profile residing outside the plane, wherein the third profiles of the first and second vertical barrier members together may define a first strengthening feature. A first and second hinge may also be included. The first hinge may be carried on the left edge and the second hinge may be carried on the right edge and configured to align with a first hinge of a second panel.

In individual examples of the present technology, each horizontal barrier member may be attached to all of the vertical barrier members.

In some configurations, the first vertical barrier member and the second vertical barrier member of the second plurality may each also be formed to include along its length a fourth profile, the fourth profile residing outside the plane, wherein the fourth profiles of the first and second vertical barrier members together define a second strengthening feature. In certain embodiments, the first strengthening feature may be disposed proximate the uppermost horizontal barrier member and parallel thereto, and the second strengthening feature may be disposed proximate the lowermost horizontal barrier member and parallel thereto.

In specific illustrations, the lowermost horizontal barrier member, the left-most vertical barrier member, and the right-most vertical barrier member of each panel may each define a side length, each uppermost horizontal barrier member, lowermost horizontal barrier member, left-most vertical barrier member, and right-most vertical barrier member being devoid of additional elements of said side length.

In selective forms, a horizontal barrier member may be attached to the first strengthening feature.

In individual configurations, a first panel may be disposed adjacent to a second panel, the first hinge of the first panel being aligned with the second hinge of the second panel, and a post interfitted within the first and second hinges.

These and other features and their advantages will be apparent from a careful review of the Detailed Description below, accompanied by the following drawings.

### BRIEF DESCRIPTION OF THE SEVERAL VIEWS OF THE DRAWING

The aspects described above, as well as other apparent aspects, advantages, and objective of the present invention are apparent from the detailed description below in combination with the drawings, in which:

FIG. 1 a perspective view of a pan& in accordance with an embodiment of the present invention;

FIG. 2 is a front elevation view of a panel in accordance with an embodiment of the present invention.

FIG. 3 is a side view of a panel in accordance with an embodiment of the present invention;

FIG. 4 is a top view of a panel in accordance with an embodiment of the present invention;

FIG. 5 is a perspective view of a hinge in accordance with an embodiment of the present invention;

FIG. 6 is an elevation view of a hinge in accordance with an embodiment of the present invention.

FIG. 7 is a top view of a hinge in accordance with an embodiment of the present invention.

FIG. 8 is an elevation view of a modular fence system in accordance with an embodiment of the present invention;

FIG. 9 is a perspective view of a latch in accordance with an embodiment of the present invention;

FIG. 10 is a magnified view, taken at A in FIG. 8;

FIG. 11 is a magnified view, taken at B in FIG. 8; and

FIG. 12 is an elevation view of a post in accordance with an embodiment of the present invention.

### DETAILED DESCRIPTION OF THE INVENTION

The present invention may be understood more readily by reference to the following detailed description, examples, drawings, and claims, and their previous and following descriptions. However, it is to be understood that this invention is not limited to the specific devices, systems, and/or component disclosed unless otherwise specified, as such can vary. It is also to be understood that the terminology used herein is for the purpose of describing particular aspects only and is not intended to be limiting.

As used in the specification and the appended claims, the singular forms “a,” “an” and “the” include plural referents unless the context clearly dictates otherwise. Thus, for example, reference to a “barrier member” can include two or more such barrier members unless the context requires otherwise.

A modular fence system 20 is provided. Modular fence system 20 comprises a minimum number of components. Modular fence system 20 includes a plurality of panels 30. Each panel 30 may be of any suitable material, and need not be of a single material but rather can be multiple materials together. Such materials may include metal, non-metal such as vinyl or plastic, fabrics such as fabric webbing, and the like.

Each panel 30 may be of any shape or geometry that includes a left side 53 and a right side 54. Each panel 30 may be planar, partially planar, or non-planar. In some embodiments, each panel 30 may be identical, but in other applications each such panel need not be identical to all other such panels 30 or identical to any other such panel 30.

Each panel 30 may define a periphery. More specifically, each panel 30 may include a top edge 51 and a bottom edge 52. Likewise, each panel 30 may include a left side edge 53 and a right side edge 54. Left side edge 53 may define along its length a first profile 61. Similarly, right side edge 54 may define along its length a second profile 62. Second profile 62 may be complimentary to first profile 61 whereby the left edge 53 of a first panel 30 may be disposed in side-by-side relationship along its length to the right edge 54 of a second panel 30 along its length.

The top edge 51, bottom edge 52, left side edge 53, and right side edge 54 of each panel 30 may each define a side length. More particularly, top edge 51 may define a first side length 41, bottom edge 52 may define a third side length 43, left side edge 53 may define a third side length 42, and right side edge 54 may define a fourth side length 44. Each side length 41, 42, 43, and 44 may be devoid of additional elements having the respective side lengths.

Top edge 51 of a panel 30 and bottom edge 52 of such panel 30 may reside in a single plane.

A plurality of barrier members 31 may reside within the periphery of a panel 30. Barrier members 31 may be metal or non-metal. Barrier members 31 may be of any advantageous cross-section, for examples, round, square, oval, or elliptical, and the cross-section or geometry may vary along the length of an individual barrier member 31. One barrier member 31 may be of a particular cross-section, yet another barrier member 31 in the same panel 30 may be of a different cross-section.

In one embodiment of modular fence system 20, barrier members 31 are of metal wire.

In a particular panel 30, a first group of barrier members 31 may cross a plurality of remaining barrier members 31. For example, such barrier members 31 in a particular panel 30 may be arranged in a diagonal and crossing orientation.

In one embodiment of system 20, a first plurality of barrier members 31, for example barrier members 35, may reside horizontally in parallel relationship to one another. A second plurality of barrier members 31, for example barrier members 34, may reside vertically in a parallel relationship to one another. In a particular embodiment, the generally horizontal barrier members, for example barrier members 35, may be attached to a plurality of the generally vertical barrier members, for example barrier members 34. In a still further embodiment, a single generally horizontal barrier member, for example barrier member 35, may be attached to all of the generally vertical barrier members, for example barrier members 34.

One example of system 20 includes panels 30 in which a first plurality of barrier members, for example barrier members 35, are identical, are rectilinear, and reside horizontally in a parallel, spaced-apart relationship to one another. Additionally, a second plurality of barrier members 31, for example barrier members 34, are identical and reside vertically in parallel, spaced-apart relationship to one another.

Each barrier member 31 may have a first end 32 and an opposed second end 33. Some, or all, of the first and second ends 31, 32 of the barrier members 31 may reside within the periphery of a panel 30.

The uppermost horizontal barrier member 31 of a panel 30 may define a top edge 51 of the panel 30. Likewise, the lower most horizontal barrier member 31 of a panel 30 may define a bottom edge 52 of the panel 30. The left-most vertical barrier member 31 may define a left edge 53 to the panel 30. Finally, the right-most vertical barrier member 31 may define a right edge 54 to the panel 30. The top edge 51, bottom edge 52, left edge 53, and right edge 54 may define a periphery of panel 30, and the entireties of the barrier members 31 of a given panel 30 may reside within the periphery of that panel 30.

In certain embodiments, a panel 30 may include only barrier members 31 and hinges, for example first hinge 81 and second hinge 82, and may be devoid of additional components.

Each panel 30 may include one or more strengthening feature, for example first strengthening feature 71. First strengthening feature 71 may be utilized so that panel 30 may resist lateral forces bearing upon it. First strengthening feature 71 may be integral with a plurality of barrier members 31. For example, a first barrier member 34a and second barrier member 34b may be identical, and each may be formed to include along its length a third profile 72, the third profile 72 residing outside the plane of the top edge 51 and bottom edge 52 wherein the third profile 72 of the first and second vertical barrier members 34a, 34b together define first strengthening feature 71.

In another embodiment, the first vertical barrier member 34a and the second vertical barrier member 34b may each be formed to include along its length a fourth profile 74, the fourth profile 74 residing outside the plane of the top edge 51 and bottom edge 52 of panel 30. In a particular application, the first strengthening feature 71 may be disposed proximate to top edge 51, and the second strengthening feature 73 may be located proximate to the bottom edge 52. In one embodiment, the first strengthening feature 71 may be disposed proximate to the uppermost horizontal barrier member 31 and parallel thereto, and the second strengthening feature 73 may be disposed proximate to the lower most horizontal barrier member 31 and parallel thereto.

One or more hinges may be provided for each panel 30 of system 20. For example, a first hinge 81 may be carried on left side edge 53. In particular applications, first hinge 81 may be carried outboard of left side edge 53. A second hinge 82 may be carried on the right side edge 54 of a panel 30, and be configured to align with the first hinge 81 of a second panel 30. In some embodiments, first and second hinges 81, 82 may be helical and, in particular applications, be disposed outboard of panel 30. Each hinge 81, 82 may be attached to a vertical barrier member 31. In some applications, first hinge 81 and second hinge 82 of each panel 30 may be helical, be identical to each other, and each may be attached to a vertical barrier member 31 outboard of the panel 30. Such attachment may be by welding, or may be by wrapping legs 83, 84 of hinge 81, 82 to a vertical barrier member 31. Similarly, hinges 81, 82 may simply be adhered to a vertical barrier member 31.

By positioning a first panel 30a and a second panel 30b adjacent to each other, with their respective hinges, for example 81b, 82b, engaged with each other and with their respective interior bores 85 aligned, a post 95 may be inserted through the interior bores 85 of each of hinges 81b, 82b, the post 95 then secured to the ground, for example by driving it into the ground, to secure system 20 in position for use.

Optionally, a latch 90 may be employed with system 20. Latch 90 may include one or more latch pins 91 and may also include one or more handles 92. Latch 90 may allow for a panel 30a to function as a gate through a system 20. More particularly, latch pin 91a may be engaged with a hinge, for example, hinge 81a, latch pin 91b being engaged with hinge 81b, and thereby a panel 30a may swing relative to an adjacent panel 30b once latch 90 is disengaged from the hinges 81a, 81b.

Furthermore, a post 95 is provided. Post 95 may be a rectilinear member defining a post thickness 96. Post thickness 96 is less than the interior bore 85 of a hinge, for example hinge 81 or hinge 82.

By use of the foregoing components, a first panel 30a may be disposed adjacent to a second panel 30b, the first hinge 81 of the first panel 30a being aligned with the second hinge 82 of the second panel 30b, and a post 95 interfitted with the first and second hinges 81, 82. In like fashion, a third panel 30c may be connected with either first panel 30a or second panel 30b. Further, additional panels 30 may be serially connected to first panel 30a or second panel 30b to create a linear fence system 20, a zig zag fence system 20, an enclosure, or boundary, or decoration of infinite shapes as the end user prefers. For example, once a third panel 30c is connected with a first panel 30a, it may then also be connected to a second panel 30b to create a triangular enclosure. Addition of a fourth panel 30d may be used to create a quadrilateral enclosure. Alternatively, a first panel 30a may be connected at its left side edge 53 to a second panel 30b, then a third panel 30c may also be connected to the left side 53 of first panel 30a to create a T-shaped barrier; additional panels 30 may then be attached to the right side edge 54 of panel 30a and to third panel 30c and to second panel 30b to create a barrier configuration desired by a particular end-user.

The accompanying figures illustrate certain of the foregoing aspects of system 20, as well as additional aspects thereof.

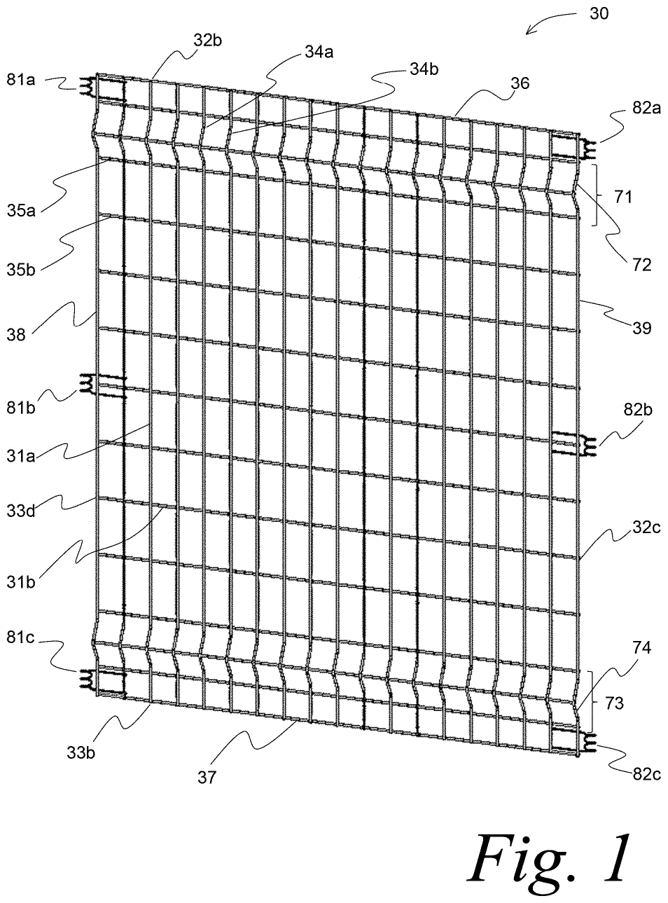

FIG. 1 illustrates a panel 30 of a system 20. Panel 30 includes plural barrier members 31, including vertical barrier members 34 and horizontal barrier members 35. Uppermost horizontal barrier member 36 and lowermost horizontal barrier member 37 are illustrated, as are left-most vertical barrier member 38, and right-most vertical barrier member 39. Barrier member 31a, a vertical barrier member, is shown to include first end 32b, and second end 33b. Barrier member 31b, a horizontal barrier member, is shown to include first end 32c and second end 33d. Horizontal barrier members 35a and 35b are also illustrated. Likewise, vertical barrier members 34a and 34b are illustrated.

FIG. 1 also illustrates third profile 72 as a component of strengthening feature 71, and fourth profile 74 as a component of second strengthening features 73.

FIG. 1 also illustrates an inclusion of first hinges 81a, 81b, and 81c. Likewise included are second hinges 82a, 82b, and 82c.

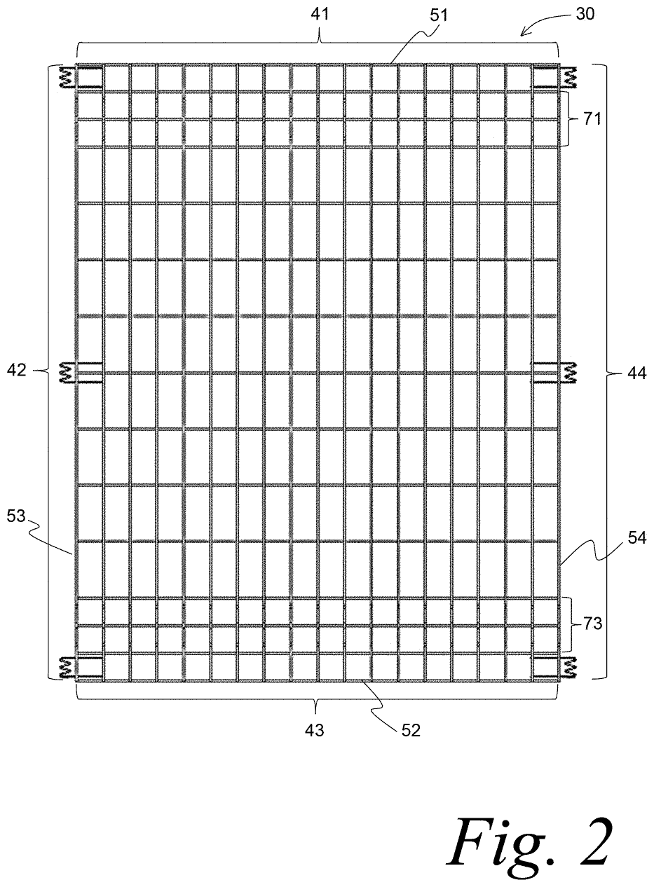

FIG. 2 illustrates top edge 51, bottom edge 52, left side edge 53, and right side edge 54. As depicted therein, top edge 51 defines first side length 41. Left side edge 53 defines second side length 42. Bottom edge 52 defines third side length 43. Right side edge 54 defines fourth side length 44. Additionally illustrated in FIG. 2 is first strengthening feature 71 and second strengthening feature 73.

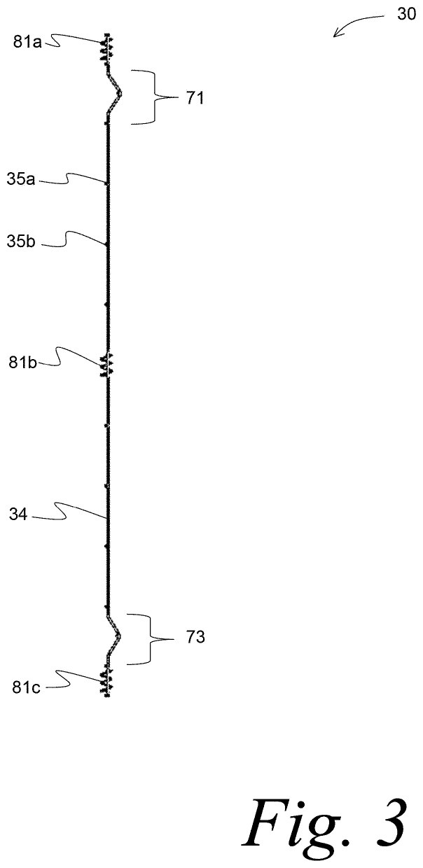

FIG. 3 is a side view of a panel 30. Illustrated therein a first hinges 81a, 81b, and 81c. Exemplary horizontal members 35a and 35b are also illustrated. First strengthening feature 71 and second strengthening feature 73 are illustrated along the length of vertical member 34.

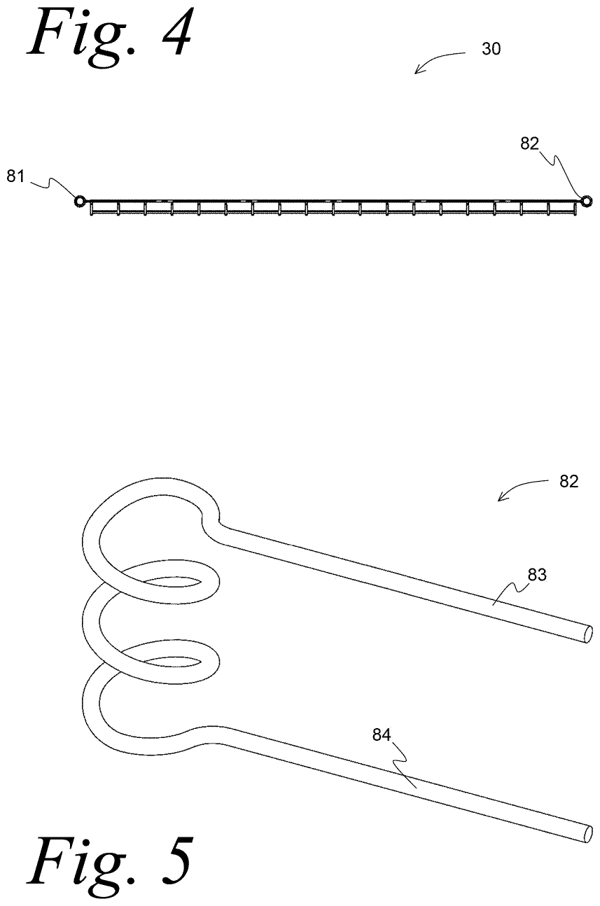

FIG. 4 is a top view of a panel 30, showing the relative positioning of first hinge 81 and second hinge 82.

FIG. 5 is a close-up view of a hinge 82. As illustrated therein, in this embodiment hinge 82 includes a first leg 83 and a second leg 84, for attachment to a vertical barrier member 34 of a panel 30.

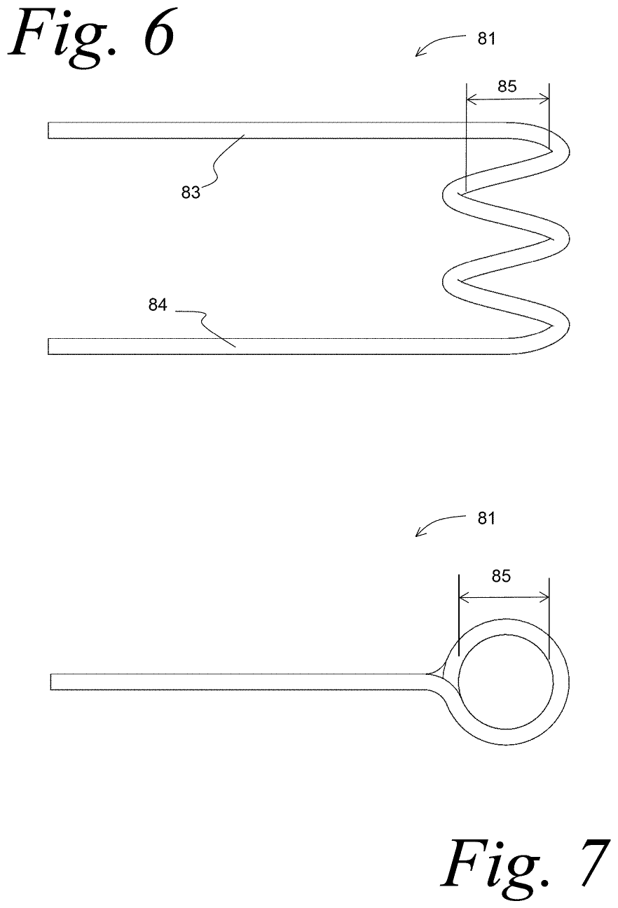

Likewise, FIG. 6 illustrates a first hinge 81. Defined between first leg 83 and second leg 84 is a helical portion that includes interior bore 85, through which a post 95, having a post thickness 96 that is less than interior bore 85, may be disposed. A similar view is included in FIG. 7.

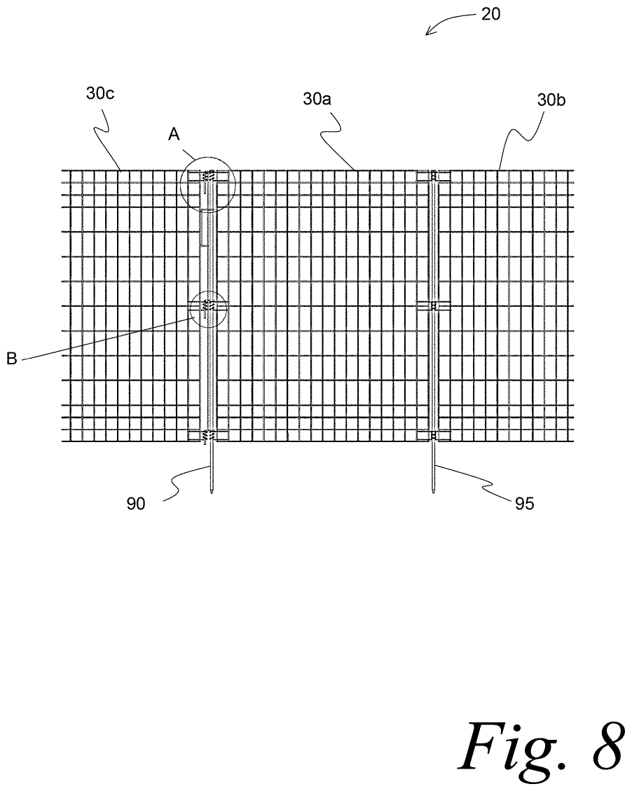

FIG. 8 illustrates system 20 comprising panels 30a, 30b, and 30c. Panels 30a, 30b have been joined together by a post 95 through hinges disposed on panels 30a, 30b (not numbered). Opposite panel 30b is disposed a panel 30c. Panel 30c has been joined with panel 30a with a latch 90. So configured, panel 30c may serve as a gate, swinging relative to panels 30a and 30b once latch 90 is disengaged from panel 30c. The illustration of FIG. 8 discloses the versatility of system 20. By serially attaching various of panels 30 one to another, either with a posts 95 and/or latches 90, an infinite variety of configurations of system 20 may be constructed. For example, with four panels 30 so joined, a quadrilateral enclosure may be constructed. Additional panels, such as fifth, sixth, seventh, and so forth panels, may likewise be attached to instruct enclosures and/or barriers of an infinite number of configurations.

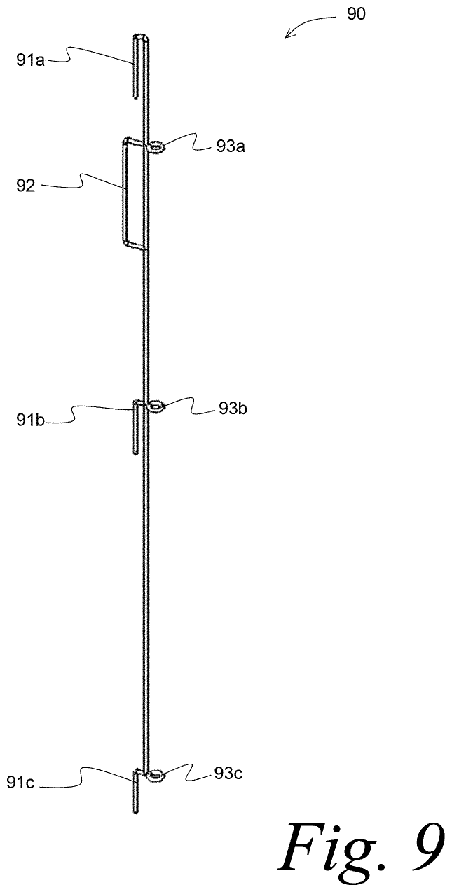

FIG. 9 is a detailed view of a latch 90. As illustrated therein, latch 90 includes latch pins 91a, 91b, 91c. In particular configurations, only a single latch pin 91 may be needed. Also included is a handle 92. Opposite latch pins 91a, 91b, and c, and handle 92 are apertures 92a, 92b and c, configured for receipt of a post 95 therethrough joining latch 90 with a panel 30.

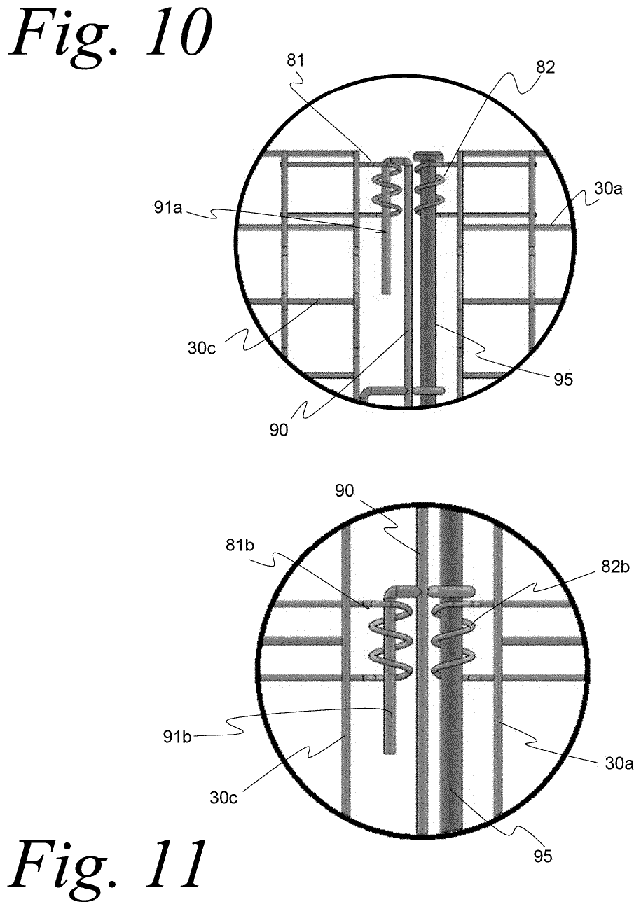

FIGS. 10 and 11 are close up views showing use of a post 90 and a latch 91 as illustrated in FIG. 8.

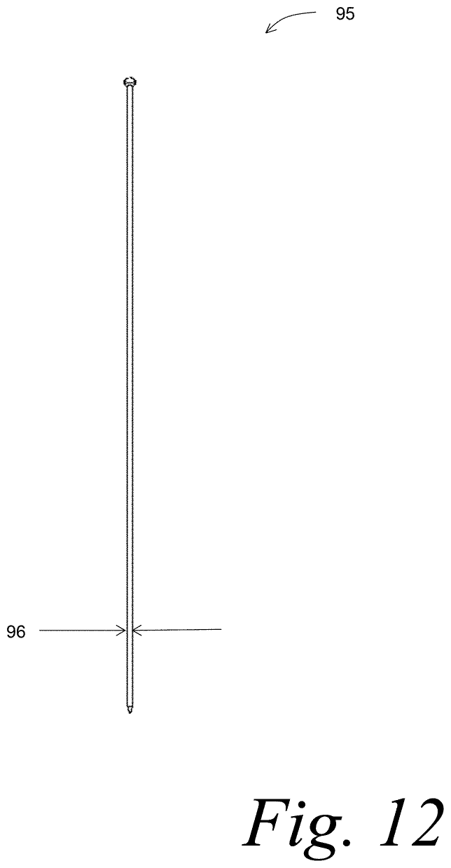

Finally, FIG. 12 shows a post 95 having a post thickness 96.

While the particular modular fence system as herein disclosed, illustrated, and described is to be understood as only an embodiment of the present invention and thus representative of the subject matter which is broadly contemplated by the present invention. The scope of the present invention fully encompasses other embodiments that may be or may become obvious to those skilled in the art, and the scope of the present invention is accordingly to be limited by nothing other than the appended claims. In the appended claims, reference to an element in the singular is not intended to mean “one and only one” unless explicitly so stated, but rather “one or more”. All structural and functional equivalents to the elements of the above-described embodiment that are known or later come to be known to those of ordinary skill in the art are expressly incorporated herein by reference and are intended to be encompassed by the present claims. Moreover, it is not necessary for a device to address each and every problem sought to be solved by the present invention for it to be encompassed by the present claims. Furthermore, no element, component, or combination in the present disclosure is intended to be dedicated to the public regardless of whether the element, component, or method step is explicitly recited in the claims. No claim element herein is to be construed under the provisions of 35 U.S.C. § 112, sixth paragraph, unless the element is expressly recited using the phrase “means for.” Absent express definitions herein, all claim terms are to be given all ordinary and accustomed meanings that are not irreconcilable with the present specification and the file history.

1. A fence gate latch, comprising:
a rectilinear body;
one or more connectors extending from a first side of the body;
a first latch pin extending from a second side of the body, the first latch pin defining an axis;
a handle extending from the body; and
the body movable relative to the fence gate from a first position to a second position.

2. The fence gate latch of claim 1, in which the second side is opposite the first side of the body.

3. The fence gate latch of claim 1, further including a second latch pin, the second latch pin residing on the axis.

4. The fence gate latch of claim 1, further including a second latch pin, the second latch pin residing on the axis, and the handle residing between the first latch pin and the second latch pin.

5. The fence gate latch of claim 1, in which the one or more connectors are plural identical apertures.

6. The fence gate latch of claim 1, in which the one or more connectors are attached to the fence gate by a post engaged with the one or more connectors.

7. The fence gate latch of claim 1, in which the one or more connectors are attached to the fence gate by a post extending through the one or more connectors.

8. The fencing system of claim 1, in which the body is biased by gravity to the first position.

9. A fencing system, comprising:
a fence gate;
a fence panel residing proximate to the fence gate;
a latch, the latch:
having a body defining an axis;
having a handle attached to the body, an aperture, and a first latch pin;
the aperture being connected to the fence gate; and
the latch movable along the axis between a first position at which the first latch pin is connected with the fence panel and a second position at which the first latch pin is disconnected with the fence panel.

10. The fencing system of claim 9, in which the fence gate has a first hinge and the aperture is connected to the fence gate at the first hinge.

11. The fencing system of claim 9, further including a post, in which the fence gate has a first hinge and the aperture is rotatably connected to the first hinge by the post.

12. The fencing system of claim 9, in which the fence panel has a second hinge and, in the first position, the first latch pin is connected with the fence panel at the second hinge.

13. The fencing system of claim 9, in which the fence panel has a second hinge and, in the first position, the first latch pin is disposed through the second hinge.

14. The fencing system of claim 9, in which the latch also has a second latch pin, the second latch pin residing colinearly with the first latch pin.

15. The fencing system of claim 9, in which the latch also has a second latch pin identical to the first latch pin, the second latch pin residing colinearly with the first latch pin.

16. The fencing system of claim 9, in which the fence panel has a second hinge and a third hinge, and the latch also has a second latch pin, wherein, in the first position, the first latch pin is disposed through the second hinge and the second latch pin is disposed through the third hinge.

17. A fencing system, comprising:
a first panel and a second panel, the first and second panels being identical;
each of the first and second panels having an outboard hinge along one side, the hinges residing proximate to each other;
a latch, the latch:
residing between the first and second panels;
attached to the hinge of the first panel;
having an outboard latch pin residing opposite the attachment to the hinge of the first panel, the outboard latch pin defining a first position and a second position, in which in the first position the latch pin is connected to the hinge of the second panel and in the second position the latch pin is disconnected from the hinge of the second panel.

18. The fencing system of claim 17, in which the latch has an aperture, it being the aperture that is attached to the hinge of the first panel.

19. The fencing system of claim 17, in which the latch pin is biased by gravity to the first position.

20. The fencing system of claim 17, in which the latch also includes a handle by which the outboard pin may be moved from the first position to the second position.
